(19) United States
(12) Patent Application Publication
(10) Pub. No.: US 2002/0110672 A1
(43) Pub. Date: Aug. 15, 2002

(54) Cosmetic skin tattoo

(76) Inventors: Joanne Muratore-Pallatino, Longmeadow, MA (US); Maryanne Muratore Hasley, East Longmeadow, MA (US)

Correspondence Address: DEBORAH A. BASILE, Doherty, Wallace, Pillsbury and Murphy, P.C., One Monarch Place, 19th Floor, 1414 Main Street, Springfield, MA, 01144-1002, US

(21) Appl. No.: 10/074,656

(22) Filed: Feb. 11, 2002

Related U.S. Application Data
(60) Provisional application No. 60/268,245, filed on Feb. 12, 2001.

(51) Int. Cl. B32B 27/14

(52) U.S. Cl. 428/195

(57) ABSTRACT

A temporary opaque tattoo for concealing veins, blemishes, wine marks, bruises, age marks and other skin conditions comprising a transfer patch to match skin tone and pigment holding an image of human skin. The image is transferred from the patch to the skin, thereby providing an opaque cover-up. An image of human skin in varying tones is provided to closely match and blend in with a variety of skin pigments and colorings. The tattoo may be of varying sizes and shapes to cover a particular skin imperfection. The tattoo may be embedded or coated with medication to provide a tattoo that both conceals and medicates a skin condition.

### CROSS REFERENCE TO RELATED APPLICATIONS

Provisional Patent Application filed Feb. 12, 2001, Ser. No. 60/268245

### STATEMENT REGARDING FEDERALLY SPONSORED RESEARCH OR DEVELOPMENT

Not Applicable

### BACKGROUND OF THE INVENTION

There are many products currently available on the market designed to cover up skin imperfections. Many of these products also contain medicine to aid in the healing of a skin problem while the imperfection is concealed.

The currently available products basically comprise various types of cosmetics or makeup. Make-up is available in a wide range of colors designed to match different skin tones. However, the disadvantage of make-up is that it may be a problem for those who tend to sweat heavily, and for those who participate in strenuous physical activities. These types of activities can cause make-up to be easily smudged, wiped or rinsed off of the skin. Additionally, the existing products offer little coverage to an individual who wishes to go swimming, or to one who might get caught in the rain. In both situations, the make-up would be removed or smeared by the water. Also, make-up is easily rubbed off and may cause embarrassing stains to the clothing, while at the same time eliminating the benefits of the cover-up.

The products used to both conceal and promote healing of skin problems are typically creams and gels that have the same disadvantages as make-up. These gels and creams easily wipe, smudge and rinse off. Those that are of a non-liquid gel or cream nature such as a bandage, which are designed to match human skin, are conspicuous in nature. They appear thick and obvious to the eye.

The following patents are known to the Inventor and are disclosed:

1. Newman U.S. Pat. No. 5,586,971

2. Dow, Jr. U.S. Pat. No. 5,120,325

3. Stanislav U.S. Pat. No. 5,817,385

4. Moir et al. U.S. Pat. No. 4,848,373

5. DeMatteo et al. U.S. Pat. No. 4,783,350

6. Baieretal. U.S. Pat. No. 4,623,593

7. Carmody U.S. Pat. No. 3,687,136

8. Relyea U.S. Pat. No. 4,594,276

9. DE 4,030,465

10. Fischer-Schreiner EP 375,810

11. Noye FR 2,425,240

12. Beam et al. GB 1,490,065

13. Felton et. al. U.S. Pat. No. 6,207,874

Newman describes an invisible bandage assembly. The assembly includes a thin piece of adhesive tape that is applied to the skin. The adhesive tape comes in different sizes and shapes. To make the tape “invisible”, make-up is applied to the surface of the tape and blended into the surrounding skin. Medication may also be added to the bandage to promote healing of the skin covered by the bandage.

Dow, Jr. describes a sterile bandage with a melanin-like pigment composition on the bandage surface. A pigment composition would be chosen to match the bandage to the skin color and to provide a bandage that blends in with the skin. The bandage may be embedded with medication.

Stanislav describes a tattoo having a printed image and being embedded with fragrance. The image relates to the fragrance in the tattoo to enable a person to more easily remember the name of a fragrance that has been sampled.

Moir et. al. describes a cosmetic sampler that is basically a packet designed to contain a portion of fragrance, make-up, pharmaceuticals, or other high viscosity, waxy materials.

DeMatteo et. al. describes a decorative full face applique. The applique is used in place of a mask on, for example, Halloween.

Baier et. al. describes a self-adhesive prosthesis that is made of a polymer composition.

Carmodv describes a bandage that is designed to blend in with one's skin coloring.

Relyea describes temporary body tattoos to be used in place of permanent tattoos. An image is printed on a translucent film or sheet material. The film or sheet material is adhesive, and the image is applied to the skin by adhering the material with the printed image to the skin. Objective is not to cover up a skin imperfection but to display a design, picture or logo on the skin as body decoration.

DE 4,030,465 describes colored self-adhesive strips, or bandages, that come in an array of tints to provide a bandage that blends in with different skin colors.

EP 375,810 Fischer-Schreiner describes colored self-adhesive and non-adhesive plasters and bandages that are applied to the skin and remain visible for short or long periods of time.

FR 2,425,240 Noye describes a self-adhesive plaster that is used to conceal scars and blemishes. The plaster is printed with a decoration, such as a flower or butterfly to provide decorative concealment.

GB 1.490.065 Beam et al. describes a self-adhesive dressing made of microporous or perforated plastic film, which has a representation of human skin printed on its surface.

Felton et. al. 6,207,874 describes a temporary tattoo for aesthetic and reconstructive purposes. Felton also describes a method of making a customized temporary tattoo used for either reconstructive or aesthetic purposes. Felton, however, does not describe a tattoo that is undetectable on the skin with no noticeable lines of demarcation on its edges. When a tattoo as described by Felton is applied to the skin, the outlines of the tattoo would be quite visible. Further, Felton would require that each custom tattoo be individually photographed and set up by a graphic artist before going to the printer. Add to that the cost and probability of finding doctors who would be willing to fit the custom tattoos and/or sell the stock tattoos to their patients. The present invention solves this problem.

The inventor knows of no product that effectively covers up a skin problem by providing a tattoo with an image of human skin. No known product provides a thin, long-lasting, and most importantly, undetectable layer of cover up.

It is an aim of the present invention to provide a product that covers-up skin imperfections nearly invisibly by providing a tattoo which is the image of human skin and which is applied directly to the skin.

It is a further aim of the present invention to provide a waterproof skin concealing product that is not easily wiped or rinsed off, by providing a temporary tattoo that may only be removed by applying alcohol or baby oil. The invention is one which may be worn while swimming and during strenuous activities without being removed inadvertently.

It is also an aim of the present invention to provide a product whose primary objective is to cover up skin imperfections while being virtually undetectable and a variation of that product with the dual objective of covering up skin imperfections, while providing a tattoo that promotes healing by coating the tattoo with an anti-bacterial material.

It is also an aim of the present invention to provide a product in a potentially unlimited number of skin tones and sizes using FDA-approved materials.

It is a further aim of the present invention to provide a product that is realistically priced through the use of mass production.

It is also an aim of the present invention to provide a product that allows the skin to remain normal visually and to the touch and have elasticity to move with the skin.

The above, and other objects, features and advantages of the present invention will become apparent from the following description read in conjunction with the accompanying drawings.

### BRIEF SUMMARY OF THE INVENTION

The present invention relates to cosmetic and medical tattoos, offering two options, one being of a cosmetic nature and the other of a medicated version. More particularly, this invention concerns temporary tattoos of varying size and shape that are manufactured using a photographic and/or computer enhanced image of human skin. The tattoos may be applied to the skin to provide an opaque and “invisible” cover-up of veins, blemishes, age marks, scars, and other skin imperfections. The tattoos may further be embedded or coated with a healing agent to provide a tattoo that both covers up and promotes healing of certain skin problems.

### BRIEF DESCRIPTION OF THE DRAWINGS

FIG. 1 is a side view of the “skin tattoo” with a healing agent.

FIG. 2 is a side view of the “skin tattoo” without a healing agent.

FIG. 3 is a top view of the “skin tattoo”

FIG. 4 is a perspective view of the “skin tattoo”

FIG. 5 shows the image of human skin as seen under a microscope, magnified 30 times.

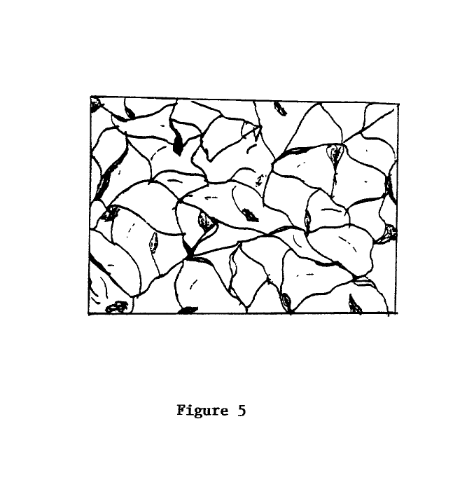

### DETAILED DESCRIPTION OF THE INVENTION

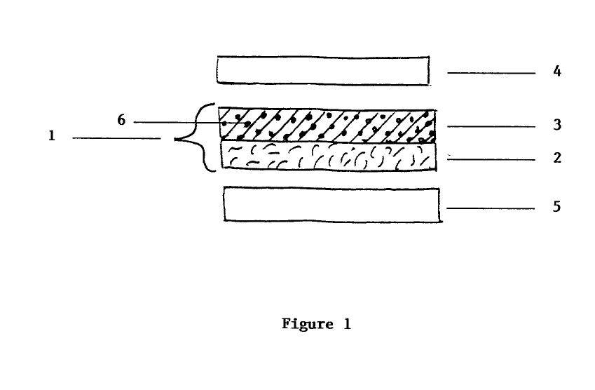

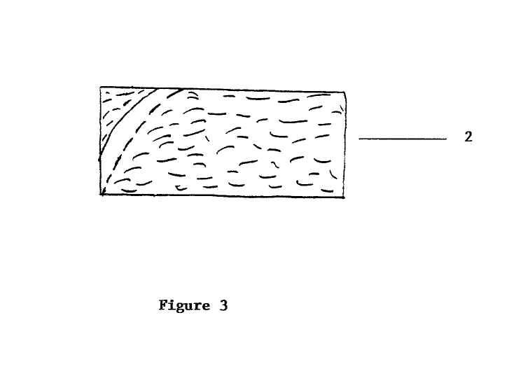

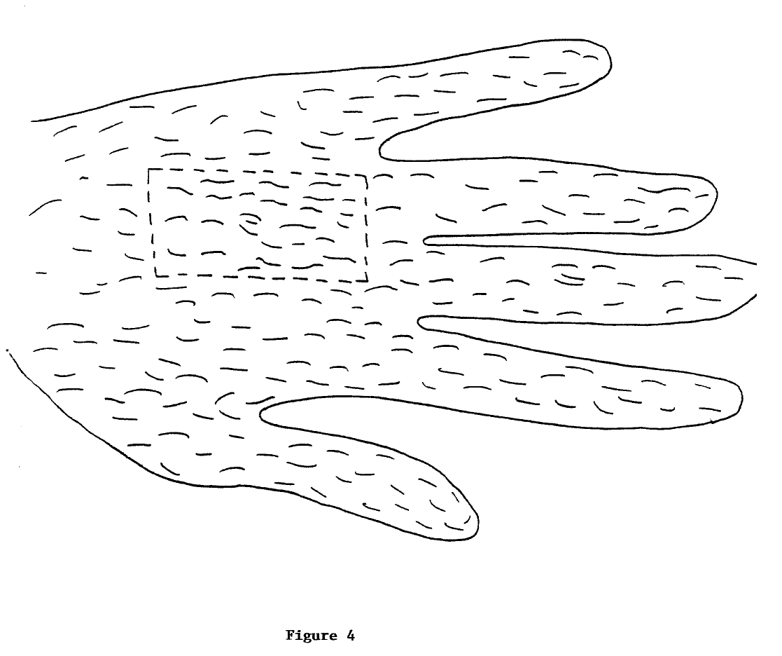

Shown in FIGS. 1-4, is the skin tattoo in accordance with the present invention.

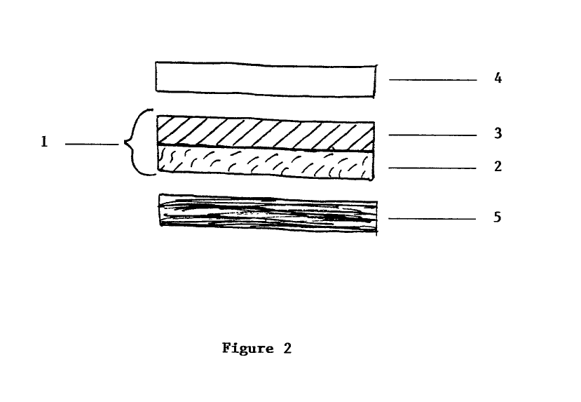

As best seen in FIGS. 1 and 2, the present invention is a tattoo which is comprised of a substrate layer 1 of film or sheet material which may be of any polymeric film formed of a flexible, porous, non-woven, compacted tissue or compacted fibrous translucent material. One surface of the substrate shall be imprinted, using FDA certified ingredients, with an image of skin 2.

The printing of the tattoo is accomplished by using a Four-Color Printing Process. The process involves the use of “feathered edging,” which is accomplished by using ink that is graduated in density. Specifically, the center portion of the tattoo contains the greatest density of ink. The density of ink gradually decreases toward the outer edges of the tattoo until a point where there is no ink. The graduated density of the ink creates a tattoo that is undetectable on the skin with no noticeable lines of demarcation at the edges.

The opposite surface of substrate will contain a pressure sensitive and moisture transmissive adhesive 3. The pressure sensitive material must also be hypoallergenic. The synthetic, acrylic adhesives such as those used on surgical tape are preferred. A disposable layer of film 4 will be placed on top of the substrate, and its purpose will be to protect the substrate layer until the image is to be transferred to the body. A final backing or carrier layer 5 which can be made of materials such as polymeric film or paper will have the image side of the tattoo placed against it.

Additionally, this invention will be produced in a medicated version of the above described product. The medicated version would consist of the invention being treated with a healing agent such as microencapsulated bactericides 6. The anti-bacterial material, which is water soluble, will be encased in shells which are of a size to be undetected by the naked eye. The microcapsules will be sprayed on or imbedded into the adhesive layer 3 of the tattoo, and will be released with the rubbing and pressure that takes place in the application process. Other healing agents such as aloe may be applied to the adhesive layer of the tattoo.

The first step in the tattoo application process is to clean and dry the area of skin where the tattoo is to be placed. Next, one would remove and discard the top protective layer of film 4 on the “skin tattoo.” The substrate 1 will then be placed, adhesive 3 side down, on the problem area of skin which is to be concealed. The back of the carrier layer 5 is then dampened with a wetting solution, and is rubbed lightly while applying a degree of pressure which is held for approximately thirty seconds. At this point, the carrier layer 5 is removed and discarded. Remaining on the skin is an opaque photographic image 2 of skin which is nearly undetectable. The offending skin condition will be hidden while the skin will remain normal to both touch and sight, having no noticeable lines of demarcation between skin and tattoo.

The “skin tattoo” would be offered in several different pigments to accommodate a large majority of the population. Many of the existing products such as face powders or concealers are available in three color choices: light, medium and dark. Because this product is being designed to be a true cover-up, an additional shade in each of the three tones would be added, such as extra light, light, medium light, medium, medium dark and dark. The consumer would then choose the shade which would appear closest to his or her natural skin tone. The tattoo, however, could be offered in a virtually unlimited number of skin tones.

Each “skin tattoo” application is designed to remain intact on the body for three to seven days. The length of time varies according to skin type and its placement on the body. The “skin tattoo” may be removed by rubbing with alcohol or baby oil.

The “skin tattoos” will be available in three different sizes. They consist of a 4×1 inch size, a 2×1 inch size, and a 1×½ inch size. The “skin tattoos” can easily be shaped to the exact size needed without affecting the viability of either the portion being sized, or the remaining portion, which could be used at a future date. The tattoo, however, may be offered in a virtually unlimited number of sizes.

In marketing this product, it is believed that certain accessory items would enhance the product in the eyes of the consumer, and that these products could be offered as a single unit in the form of a kit. Each kit would contain approximately one dozen “skin tattoos”, one dozen sealed packets of wipes saturated with a skin cleansing product such as hydrogen peroxide (a product which appears to extend the life of the “skin tattoo” without interfering with the chemical process that is taking place), a spray bottle containing a wetting solution, and a small sponge.

Additionally, a finishing powder may be placed on the tattoo. The finishing powder extends the life of the tattoo. The finishing powder prevents the tattoo from fading or darkening.

What is claimed is:

1. A temporary tattoo comprising:
A flexible substrate with front and back surfaces;
An image of skin imprinted on said front surface of said flexible substrate;
An adhesive affixed to said back surface of said flexible substrate;
A removable, disposable covering layer affixed to said adhesive on said back surface of said flexible substrate;
A removable, disposable backing layer affixed to said image of skin on said front surface of said flexible substrate.

2. The temporary tattoo of claim 1 in which said image of skin is imprinted on said front surface of said flexible substrate with ink that is graduated in its density so that a greater amount of ink is concentrated in the center of said tattoo and a lesser amount of ink on the outer edges of said tattoo.

3. The temporary tattoo of claim 1 in which said image of skin is imprinted on said front surface of said flexible substrate with waterproof ink.

4. The temporary tattoo of claim 1 in which the said adhesive affixed to said back surface of said flexible substrate is hypo-allergenic, moisture transmissive, and pressure sensitive.

5. The temporary tattoo of claim 1 in which the said adhesive affixed to said back surface of said flexible substrate contains an agent to aid in healing.

6. A temporary tattoo comprising:
A flexible substrate with front and back surfaces;
An image of skin imprinted on said front surface of said flexible substrate, said image of skin is imprinted on said front surface of said flexible substrate with ink that is graduated in its density so that a greater amount of ink is concentrated in the center of said tattoo and a lesser amount of ink on the outer edges of said tattoo, said ink being waterproof.
An adhesive affixed to said back surface of said flexible substrate, said adhesive is hypo-allergenic, moisture transmissive, and pressure sensitive.
A removable, disposable covering layer affixed to said adhesive on said back surface of said flexible substrate, said covering layer is film;
A removable, disposable backing layer affixed to said image of skin on said front surface of said flexible substrate.

7. The temporary tattoo of claim 6 in which the said adhesive affixed to said back surface of said flexible substrate contains an agent to aid in healing.

8. A kit comprising:
At least one temporary tattoo;
At least one cleansing product;
A wetting solution;
A sponge.

9. The kit of claim 8 in which the skin cleansing product is hydrogen peroxide.

10. The kit of claim 8 in which the wetting solution is contained in a spray bottle.

11. The kit of claim 8 further comprising a finishing powder.
